(19) United States
(12) Patent Application Publication
(10) Pub. No.: US 2005/0222990 A1
(43) Pub. Date: Oct. 6, 2005

(54) Methods and systems for using script files to obtain, format and disseminate database information

(76) Inventor: Kenneth T. Milne, Netherlee (GB)

Correspondence Address: DOCKET ADMINISTRATOR;LOWENSTEIN SANDLER PC, 65 LIVINGSTON AVENUE, ROSELAND, NJ, 07068, US

(21) Appl. No.: 10/889,656

(22) Filed: Jul. 12, 2004

Related U.S. Application Data
(60) Provisional application No. 60/559,765, filed on Apr. 6, 2004.

(51) Int. Cl. G06F 7/00

(52) U.S. Cl. 707/3

(57) ABSTRACT

A computer-implemented method for managing a plurality of data feeds includes the steps of obtaining a script, the script for specifying a query and creating a data feed; executing the query against a database to produce a result set; and formatting the result set in accordance with the script to create the data feed. The script preferably also specifies a manner in which the data feed is to be formatted (such as a flat file, a spreadsheet file, an HTML file, an XML file, or a PDF file) and a transport method (such as electronic mail (e-mail), FTP, or ESItran). Preferably, the script specifies the database name and logon parameters. The query preferably references a procedure that executes SQL commands against the named database. The script can be stored as a text file written in a suitable specification language to provide direction as to obtaining, formatting, and disseminating the desired information. Preferably, the script is stored as a JAVA properties file.

### CROSS REFERENCE TO RELATED APPLICATIONS

This application claims the benefit of U.S. Provisional Application Ser. No. 60/559,765, filed by Milne et al. on Apr. 6, 2004 and entitled “Methods and Systems For Using Script Files To Obtain, Format and Disseminate Database Information”, which is incorporated herein by reference.

### FIELD OF THE INVENTION

The present invention relates generally to database systems, and, more particularly, to methods and systems for using a script file to obtain, format, and disseminate database information.

### BACKGROUND OF THE INVENTION

Organizations such as financial institutions are responsible for maintaining a large number of data feeds. These data feeds are typically produced at certain times of the day and delivered in electronic form to various users. An example of a data feed is a spreadsheet file containing information obtained from a database. A typical recipient would be an employee in the organization such as a financial analyst.

Typically, a computer program must be written in a high-level language such as C++ or JAVA for each data feed which is desired. Thus, an end-user who wishes to have information obtained from a database, would have a special program written by a programmer that defines the database to access along with the SQL commands to execute. The program would need to interact with various systems to have the information sent to the recipient in the proper format.

Unfortunately, the conventional approach has many drawbacks. Each request for information requires a programmer to code a separate program. Because of the expertise required for this task, it often takes a considerable amount of time to implement even a relatively simple request. Furthermore, this approach leads to a proliferation of programs written in a variety of different languages that can be difficult and expensive to maintain. Accordingly, improved methods and systems for managing a plurality of data feeds are needed.

### SUMMARY OF THE INVENTION

The present invention provides improved methods and systems for using script files to obtain, format and disseminate database information.

According to an aspect of the invention, a computer-implemented method for managing a plurality of data feeds is provided. The computer-implemented method for managing a plurality of data feeds includes the steps of obtaining a script, the script for specifying a query and creating a data feed; executing the query against a database to produce a result set; and formatting the result set in accordance with the script to create the data feed. The script preferably also specifies a manner in which the data feed is to be formatted (such as a flat file, a spreadsheet file, an HTML file, an XML file, or a PDF file) and a transport method (such as electronic mail (e-mail), FTP, or ESItran).

Preferably, the script specifies the database name and logon parameters. The query preferably references a procedure that executes SQL commands against the named database. The script can be stored as a text file written in a suitable specification language to provide direction as to obtaining, formatting, and disseminating the desired information. Preferably, the script is stored as a JAVA properties file.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a high-level diagram of an exemplary system for disseminating database information;

FIG. 2 is an exemplary script file for sending a data feed as an e-mail attachment; and

FIG. 3 is an exemplary flow chart outlining a method for disseminating database information.

### DESCRIPTION OF PREFERRED EMBODIMENTS

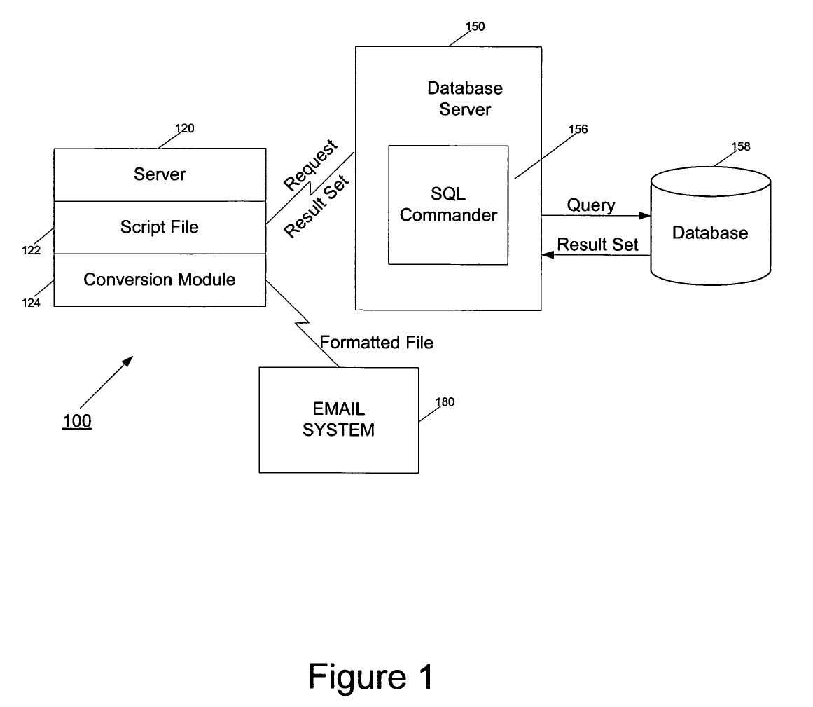

Referring to FIG. 1, a system for disseminating database information 100 includes a Server 120 that executes a program for accessing a Script File 122 to obtain instructions for creating, formatting and forwarding a data feed. Typically, the Script File 122 contains a series of custom instructions written in a text-based script language. As an example, the Server 120 might be instructed to access a particular database to retrieve specified information and format this information in a particular manner for a designated user.

The Server 120 is operatively coupled to a Database Server 150 such that a plurality of predefined database commands (e.g., SQL commands) are executed. As depicted in FIG. 1, the Database Server 150 includes a SQL Commander 156 for selecting and executing a query against a Database 158. When the Database Server 150 is called, a request for a particular set of SQL commands is received and the SQL Commander 156 selects the pertinent query for the Database 158. The SQL Commander 156 executes the predefined SQL statements, and returns a result set to the Database Server 150. In turn, the Database Server 150 returns the result set to the Server 120.

Once the result set for the particular query is received, the Script File 122 is again consulted to determine the format for the data feed. In general, the result set will be in a form that is not readable. The result set will be converted to a suitable format such as a flat file, an Excel spreadsheet file, a Word file, or a PDF file. In order to convert the result set into the specified format, the Server 120 calls a Conversion Module 124 for this purpose. The Conversion Module 124 could be an off-the-shelf module or one that is specially written. Preferably, the Conversion Module 124 will be implemented in such a way that various different formats are supported and additional ones are easily added.

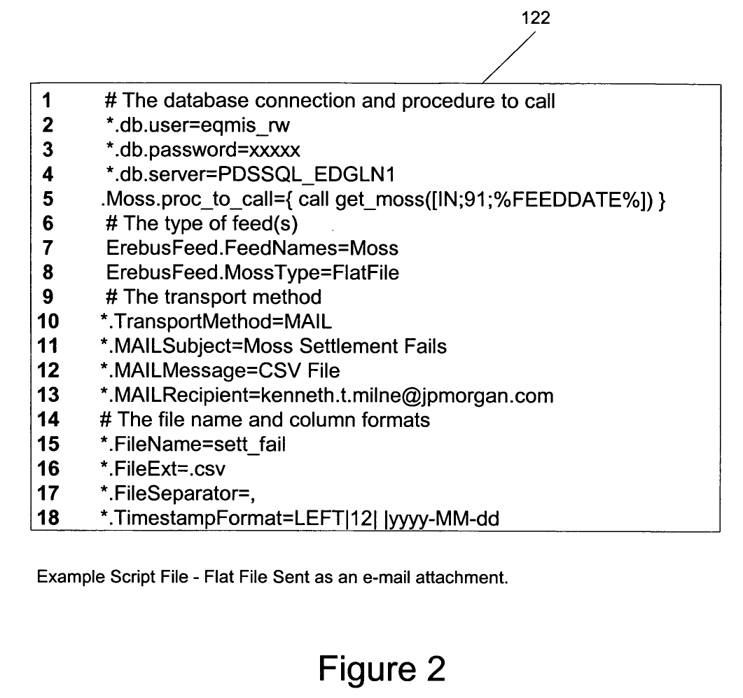

Referring to FIG. 2, an exemplary script file 122 is illustrated. The script file 122 shown in FIG. 2 instructs the Server 120 to create a flat file and to send the flat file as a e-mail attachment. The Server 120 interfaces with an e-mail system 180 in order to accomplish the task. It is to be appreciated that the script file 122 shown in FIG. 2 is provided for illustrative purposes.

As depicted in FIG. 2, the script file 122 appears as a series of commands in a text file. The syntax for the Script File 122 shown and discussed herein involves a syntax that is close to that of a JAVA properties file. However, it is to be appreciated that the script file could be written in another suitable language so long as it is capable of defining the way in which the data feed is to be created, formatted and disseminated. However, the use of a JAVA properties file for this purpose is a preferred method of creating the Script File 122.

As will be discussed in greater detail, the exemplary Script File 122 shown in FIG. 2 sets forth each of the parameters needed by the Server 120 to create, format and deliver the data feed. Line 1 of this file is a comment since it starts with the number (#) sign. Lines 2 and 3 define the user name and password. Line 4 defines the server name. In this case, it is PDSSQL_EDGLN1. Lines 5 defines the procedure to call that is executed by the Database Server 150. Various parameters would typically be passed. Line 6 is another comment. Lines 7 and 8 define the types of feed. In this case, the feed is named “Moss” and is a flat file. Line 9 is comment. Lines 10-14 define the transport method. In this case, the method is e-mail and the message will include the subject line “Moss Settlement Fails” and the body of the message will contain the words “CSV File” The e-mail address of the recipient is also indicated. Line 15 is another comment. Lines 16-19 define the file name and column formats. In this case, the file name will be “sett_fail” and the extension for the file would be “.csv”. The file separator would be a comma. Dates would be indicated as left justified in the format yyyy-MM-dd.

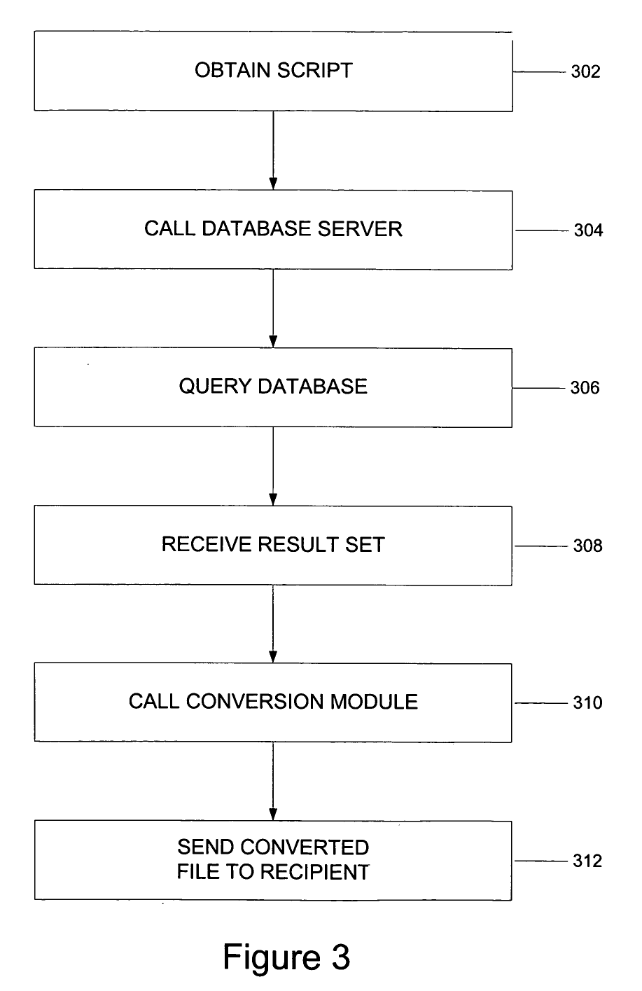

Referring to FIG. 3, an exemplary method for disseminating database information is illustrated.

First, in step 302, a script file is obtained to determine instructions for creating, formatting and disseminating a data feed. As discussed above, the script file is preferably a JAVA properties file. The script file will typically include the name of the database to access as well as the user id and password information. Next, in step 304, database access is established and a call to a database server is done. The database server will receive information regarding a set of SQL predefined commands to access. In step 306, the database server queries the database with the predefined SQL commands. In step 308, a result set for the particular query is received.

Once the result set is available the script file is consulted to determine the proper format and transport method. In step 310, a conversion module is called to format the result set into the proper format specified by the script file. Finally, in step 312, the converted file is delivered to the recipients indicated in the script file, and processing ends.

The invention will be clarified by the following example.

### EXAMPLE

### Properties File

A properties file is located in $HOME/properties. The name should be in the format “<name><region>.properties” where <name> is the name given to the feed and <region> is In, ny, tk or blank. (A region is a geographic area where processing is to take place, such as London, New York or Tokyo).

### Specifying the Feeds

The invention can invoke one or more different generic data feeds. The feeds to be invoked are specified by the ‘FeedNames’ property and the type of each feed is specified by the ‘<name>Type’ property where <name> appears as one of the values in the ‘FeedNames’ property. The feeds and their type enter properties are specified according to the format below.

SystemFeed.FeedNames=<list of names>

SystemFeed.<name>Type=<type>

where

<list of names> is one or more names separated by spaces.

<name> is the name that appears in the <list of names> above.

<type> is the generic type of the feed
(currently FlatFile, HtmlFile, ExcelFile and FileLoader are supported).
   A ‘<name>Type’ property must be specified for each name in the <list of names>. The feeds will be started in the order in which they are specified in the <list of names>.

### Calling the Stored Procedure

Data feeds of type ‘FlatFile’, ‘HtmlFile’, ‘ExcelFile’ and ‘FileLoader’ can call a stored procedure. The procedure name and parameters are specified in the properties file as follows. Note the full stop at the start of the line—it denotes that the property name should not have the class name prepended.

.<name>.proc_to_call={call <proc>(<list of params>)}

where

<name> is the name of the feed.

<proc> is the name of the stored procedure to be called.

<list of params> is a list of parameters separated by commas.

Each parameter in <list of params> is of the following form.

[<reg>;<type>;<value>]

where

<reg> specifies whether the parameter in an ‘IN’, ‘OUT’ or ‘INOUT’ parameter.

<type> indicates the SQL type of the parameter as defined in java.sql.Types.java.

<value> is one of the values in the Table 1 below.

TABLE 1

| Value | Parameter passed to stored procedure |
|---|---|
| hard-coded value | Given value converted to appropriate type |
| %FEEDDATE% | Value of “-d” parameter, or if no “-d” then the current |
| | date |
| %NULL% | Null value of the appropriate type |
| %-<single | Value immediately following “-<single char>” in feed |
| char>% | parameters |

All “float” and “double” floating-point variables passed to the stored procedure are passed as BigDecimal types to avoid rounding errors. If a particular “-<single char>” parameter is specified in the parameter list but is not given in the feed parameters then a null value of the appropriate type will be passed instead.

### Calling SQL

Feeds of type ‘FileLoader’ can also call inline SQL. The SQL is specified in the properties file as follows. Note the full stop at the start of the line—it denotes that the property name should not have the class name prepended.

.<name>.sql_to_call=<SQL>

Parameter values passed to the feed and %FEEDDATE% can be substituted into the SQL in the same way as they are substituted into stored procedures as described above.

### Outputting Result Sets

The file name (or names) in which to output the result set (or sets) returned by the stored procedure are specified as in the properties file that follows. If the “FileName” property has the value “SeparateFiles” then each result set will be written to a separate file with the first result set returned being written to the file name specified by the “FileName1” property etc.

Either

<name>.FileName=<file name>

or

<name>.FileName=SeparateFiles

<name>.FileName1=<file name 1>

<name>.FileName2=<file name 2>

. . .

<name>.FileName<n>=<file name n>

where

<name> is the name of the feed.

<file name> is any file name with substitutions performed as in the table below.

<n> should match with the number of result sets returned by the stored procedure.

The value of the FileName property may contain certain values which are substituted as shown in Table 2 below.

TABLE 2

| Value in file name | Value that is substituted |
|---|---|
| %FEEDDATE% | Value of “-d” parameter, or if no “-d” then the |
| | current date |
| %FEEDREGION% | Value of FileRegion property in properties file or |
| | none is given, the feed region passed into the feed. |
| %-<single char>% | Value immediately following “-<single char>” in |
| | feed parameters |

### Configuration Properties

Other properties allow further configuration of the feed as shown in Table 3 below. The property name should have either “*.” or “<feed name>.” prepended depending on whether it applies to all feeds or a single feed. All properties with string values default to null and all properties with boolean values default to ‘false’. Any property values of the form ‘$<variable>’ are assumed to be environment variables and the <value> passed as a system property parameter (i.e. as -D<variable>=<value>) will be substituted.

TABLE 3

| Property | Configures | Value | Applies to |
|---|---|---|---|
| TMinusOne | Changes the feed date to T-1 | true or false | Flat File |
| | | | Html File |
| | | | Excel File |
| | | | Load File |
| ResultSetSeparator | Text to be output between result | Any string | Flat File |
| | sets | | |
| ResultSetPre | The text to appear before the result | Any string or | Html File |
| | set | HTML | |
| ResultSetPost | The text to appear after the result | Any string or | Html File |
| | set | HTML | |
| ResultSetCaption | The caption for the table the result | Any HTML | Html File |
| | set appears in | | |
| CompletionFileName | The name of a file to be sent after | Any string | Flat File |
| | the feed file is sent | | Html File |
| | | | Excel File |
| FileExt | The file extension to be appended | Any string | Flat File |
| | | | Html File |
| | | | Excel File |
| | | | Load File |
| FileRegion | Populates %FEEDREGION% in | Any string | Flat File |
| | the feed file name | | Html File |
| | | | Excel File |
| | | | Load File |
| ReportsDir | The directory where the file should | Any directory | Flat File |
| | be written (before/after transporting | | Html File |
| | or copying to sent directory | | Excel File |
| | | | Load File |
| TransportMethod | Method by which the file is | FTP, | Flat File |
| | transported (if more than one | ESITRAN, | Html File |
| | method is required they should be | MAIL (not for | Excel File |
| | separated by whitespace) | Load File) or | Load File |
| | | NONE | |
| TransportLater | If set to true the file will be | true or false | Flat File |
| | transported by the next feed which | | HtmlFile |
| | has the property unset or set to | | Excel File |
| | false. Can to used to send files | | |
| | from separate feeds in the one e- | | |
| | mail. | | |
| DateSuffix | Is date to be appended when | true or false | Flat File |
| | moved to SENT directory | | Html File |
| | | | Excel File |
| | | | Load File |
| ShowHeaders | Are column headings to be written | true or false | Flat File |
| | as a header row | | Html File |
| | | | Excel File |
| FileSeparator | The text that separates field values | Any string | FlatFile |
| StartingSeparator | Should a FileSeparator appear at | true or false | FlatFile |
| | the start of the line | | |
| EndingSeparator | Should a FileSeparator appear at | true or false | FlatFile |
| | the end of the line | | |
| FileHeader | The text that appears at the very | Any string | FlatFile |
| | start of the file. | (with \n as | |
| | | necessary) | |
| FileFooter | The text that appears at the very | Any string | FlatFile |
| | end of the file. | (with \n as | |
| | | necessary) | |
| EOLCharacters | The text that terminates a row | Any string | FlatFile |
| | (usually \n or \n\r) | | |
| ShowWhenEmpty | Should a table or sheet appear if it | true or false | Html File |
| | is empty | | Excel File |
| SheetName | The name of the sheet (use | Any string | Excel File |
| | SheetName<n> for result set <n> | | |
| SheetOrder | The order of the sheet (use $, or $- | Any number | Excel File |
| | 1 to indicate the last, last but one | | |
| | sheet | | |
| FileDateFormat | Date format if %FEEDDATE% is | Date format | FlatFile |
| | included in the file name | string | HtmlFile |
| | | | Excel File |
| | | | Load File |

Properties that are specific to transport and loading methods are shown in Table 4.

TABLE 4

| | |
|---|---|
| FTPServer | The FTP server |
| FTPUser | The FTP user |
| FTPPassword | The FTP user's password |
| FTPDirectory | The directory where the file should be placed on the |
| | FTP server |
| FTPBinaryMode | If set true then use binary mode ftp. Defaults to false. |
| ESITranDir | The directory from where the ESITran route copies |
| | files |
| ESITranRoute | The ESITran route identifier |
| MAILSubject | Subject of the mail |
| MAILMessage | The text body of the mail message |
| MAILRecipient | The user to which the mail is to be sent |
| MAILCCList | The CC list of the mail |
| MAILBCCList | The blind CC list of the mail |
| LoadTable | The table loaded via BCP |
| LoadServer | The server to be used by BCP |
| LoadUser | The user for BCP |
| LoadPassword | The password for BCP |
| LoadSeparator | The BCP separator |

### Formatting Result Sets

The values returned from the stored procedure result sets can be formatted on a type or column name basis. To format a value in the result set the format property for a particular column is applied first. If this does not exist then the format property of its generic type will be applied. If neither exist the default Java formatting is applied. The format property name should have either “*.” or “<feed name>.” prepended depending on whether it applies to all feeds or a single feed. Double and numeric types use the BigDecimal class to avoid rounding errors. The property <column name> below is the name of the table column as returned in the result set meta data.

TABLE 5

| Format Property Name | Formats Objects of Type |
|---|---|
| Date | DATE |
| Timestamp | TIMESTAMP |
| Double | DOUBLE |
| Decimal | NUMERIC |
| Integer | INTEGER, SMALLINT |
| String | CHAR, VARCHAR |
| <column name> | As specified in the result set meta data |

All the above properties shown in Table 5 have value fields of the following form. The default field separator character (which is shown below) is “|” but this can be changed by including a property FormatSeparator=<string> if the <format> string needs to contain a “|” itself.

<property>Format=<justify>|<width>|<pad>|<format>

where

<justify> is LEFT, RIGHT to left, right justify the field or IGNORE for no output

<width> is the width of the field or 0 if the field should not be padded or truncated

<pad> is the character to use to pad the field if necessary

<format> is one of the following
“.” for no formatting.
“Scale:<m>.<n>” for implied decimal places.
Any of the formats shown in java.text.DecimalFormat.java.
Any of the formats shown in java.text.SimpleDateFormat.java.

Format strings of the form described in java.text.DecimalFormat.java may also contain the characters “FormatDecimalPlaces”. These characters are replaced by the contents of a column in the result set where the name of the column as returned in the result set meta data is “FormatDecimalPlaces”. For example to format decimal values to have the appropriate number of decimal places for their currency, return the following in a select statement

select

ct_dp_ccy as “FormatDecimalPlaces”

from

CURRENCY

and specify a format such as “*.DoubleFormat=LEFT|20|
|#,##0FormatDecimalPlaces” in the properties file.

When formatting in excel format each cell type is set using the type returned for the result set column by default. This allows a user to modify the format as required in Excel. If however all the cells should be created as text cells the following property should be specified.

ExcelStyleCellFormat=false

By default, the column headings output are simply the name of the table column as returned in the result set meta data. This can be changed by the following property.

<column>ColumnHeading=<heading>

where

<column> is the name of the column as returned in the result set meta data.

<heading> is the text string to be displayed as the column heading.

### Substituting Parameter Values in Properties

Parameter values can be substituted into property values by including %-<char>% in the property value. If the parameter has been specified on the command line, then the value of the parameter will replace %-<char>% in the property value. If %-<char>% appears in a property but has not been specified on the command line then the value of the property “<char>DefaultParameter” will be substituted, if one exists. For example consider the parameter “-s” and the properties below.

*.Prop=Run for %-s%

*.sDefaultParameter=today

If -syesterday is passed as a parameter, the ‘Prop’ property value will be “Run for yesterday”, but if no -s parameter is passed as a parameter, the ‘Prop’ property value will be “Run for today”.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A computer-implemented method for managing a plurality of data feeds, comprising the steps of:
obtaining a script, the script for specifying a query and creating a data feed;
executing the query against a database to produce a result set; and
formatting the result set in accordance with the script to create the data feed.

2. The method of claim 1, wherein the script further specifies a transport method.

3. The method of claim 2, further including the step of sending the data feed according to the specified transport method.

4. The method of claim 1, wherein the script further specifies a database name.

5. The method of claim 4, wherein the query is referenced as a stored procedure that executes SQL commands against the named database.

6. The method of claim 1, wherein the script is stored as a text file.

7. The method of claim 1, wherein the script is a JAVA properties file.

8. The method of claim 4, wherein the data feed is formatted as one of a flat file, an spreadsheet file, an HTML file, an XML file, and a PDF file.

9. The method of claim 2, wherein the transport method is one of electronic mail (e-mail), FTP, and ESItran.

10. The method of claim 1, wherein the format specifies one or more format type options.

11. A system for managing a plurality of data feeds, comprising:
a computer-readable memory; and
a processor communicatively coupled to the computer-readable memory, the processor programmed to perform actions comprising:
obtaining a script, the script for specifying a query and creating a data feed;
executing the query against a database to produce a result set; and
formatting the result set in accordance with the script to create the data feed.

12. The system of claim 11, wherein the script further specifies a transport method.

13. The system of claim 12, wherein the processor is further programmed to perform the action of sending the data feed according to the specified transport method.

14. The system of claim 11, wherein the script further specifies a database name.

15. The system of claim 14, wherein the query is referenced as a stored procedure that executes SQL commands against the named database.

16. The system of claim 11, wherein the script is stored as a text file.

17. The system of claim 1, wherein the script is a JAVA properties file.

18. The system of claim 14, wherein the data feed is formatted as one of a flat file, an spreadsheet file, an HTML file, an XML file, and a PDF file.

19. The system of claim 12, wherein the transport method is one of electronic mail (e-mail), FTP, and ESItran.

20. The system of claim 11, wherein the format specifies one or more format type options.

21. A program storage device readable by a machine, tangibly embodying a program of instructions executable on the machine to perform method steps managing a plurality of data feeds, the method steps comprising:
obtaining a script, the script for specifying a query and creating a data feed;
executing the query against a database to produce a result set; and
formatting the result set in accordance with the script to create the data feed.
